(19) United States
(12) Patent Application Publication
(10) Pub. No.: US 2026/0102693 A1
(43) Pub. Date: Apr. 16, 2026

(54) TRACKING MULTI-USER ENGAGEMENT ACROSS REAL-WORLD & DIGITAL ENVIRONMENTS

(71) Applicant: SONY INTERACTIVE ENTERTAINMENT LLC, SAN MATEO, CA (US)

(72) Inventor: Melissa Soucie, San Mateo, CA (US)

(21) Appl. No.: 18/913,042

(22) Filed: Oct. 11, 2024

(51) Int. Cl. A63F 13/216; A63F 13/332; A63F 13/69; A63F 13/79

(52) U.S. Cl. CPC A63F 13/216; A63F 13/332; A63F 13/69; A63F 13/79

(57) ABSTRACT

Systems and method for tracking multi-user engagement across real-world and digital environments are provided. A user account associated with gameplay may be linked to a code, which may further be embedded or presented on a physical collectible item. The user may digitally check into real-world events by having their code scanned or otherwise detected at a real-world location. Geolocation data associated with multiple different users may be used to track interactive group activities of the users in the real-world environment, as well as to prompt interactive group activities by notifying the users that they are within a real-world proximity of other users with whom they may have interacted with in digital environment (e.g., played games together, spectated each other's games).

### BACKGROUND OF THE INVENTION

### 1. Field of the Invention

The present invention generally relates to tracking multi-user engagement across real-world and digital environments. More specifically, the present invention relates to use of physical collectibles for tracking multi-user engagement across real-world and digital environments.

### 2. Description of the Related Art

Presently available digital interactive content allow for interaction among multiple users within digital environments. Such interactions may include not only conversational interactions, but also interactions driven by concurrent engagement with digital content (e.g., video games) during the same interactive session. For example, during gameplay of the same video game title, one player may directly or indirectly (e.g., through an avatar) interact with other players and/or their respective avatars. A gameplay session may include or be associated with a concurrent chat sessions by text, audio, or video, as well as in-game interactions between avatars in the virtual environment. Players may thus engage with other players in digital environments while each respective player is located at different real-world locations.

Such interaction between individual players in such online or digital settings do not necessarily extend into real-world settings, however. Because players who encounter and engage with each other in digital environments may often use avatars or other digital characters to represent themselves, the players may not recognize each other in the real-world despite being open to and interested in doing so. Individuals who wish to engage with their online friends in offline, real-world setting must generally make their own arrangements to do so, which may include exchanging real-world contact information, planning real-world events, or coordinating meetups. Such arrangements may be time-consuming and complicated, especially for large groups, as well as failing to take advantage of serendipitous, chance encounters. The converse may also be true of real-world encounters with individuals with whom a player may later engage in gameplay unaware of they may have already met in the real-world.

There is, therefore, a need in the art for improved systems and methods for tracking user engagement across real-world and digital environments.

### SUMMARY OF THE CLAIMED INVENTION

Embodiments of the present invention include systems and method for tracking multi-user engagement across real-world and digital environments. A user account associated with gameplay may be linked to a code, which may further be embedded or presented on a physical collectible item. The user may digitally check into real-world events by having their code scanned or otherwise detected at a real-world location. Geolocation data associated with multiple different users may be used to track interactive group activities of the users in the real-world environment, as well as to prompt interactive group activities by notifying the users that they are within a real-world proximity of other users with whom they may have interacted with in digital environment (e.g., played games together, spectated each other's games).

### BRIEF DESCRIPTION OF THE DRAWINGS

FIG. 1 illustrates an exemplary network environment in which a system for tracking user engagement across real-world and digital environments may be implemented.

FIGS. 2A-C illustrate exemplary physical collectible items that may be used to track user engagement across real-world and digital environments.

FIGS. 3A-B illustrate an exemplary configuration of a dock used to display content associated with physical collectible items.

FIG. 3C illustrates an exemplary implementation in which multiple display docks may be aligned together.

FIG. 4 illustrates an exemplary kiosk where physical collectible items may be obtained and registered with user accounts.

FIG. 5 illustrates an exemplary real-world environment in which a system for tracking user engagement across real-world and digital environments may be implemented.

FIGS. 6A-F illustrate exemplary screenshots of graphical user interfaces (GUIs) that may be presented on a user device as user engagement is tracked across real-world and digital environments.

FIGS. 7A-B illustrate exemplary exchanges of digital content between two user devices.

FIG. 8A is a flowchart illustrating an exemplary method for tracking user engagement across real-world and digital environments.

FIG. 8B is a flowchart illustrating an alternative method for tracking user engagement across real-world and digital environments.

FIG. 9 is a block diagram of an exemplary electronic entertainment system for implementing aspects of the present disclosure.

### DETAILED DESCRIPTION

Embodiments of the present invention include systems and method for tracking multi-user engagement across real-world and digital environments. A user account associated with gameplay may be linked to a code, which may further be embedded or presented on a physical collectible item. The user may digitally check into real-world events by having their code scanned or otherwise detected at a real-world location. Geolocation data associated with multiple different users may be used to track interactive group activities of the users in the real-world environment, as well as to prompt interactive group activities by notifying the users that they are within a real-world proximity of other users with whom they may have interacted with in digital environment (e.g., played games together, spectated each other's games).

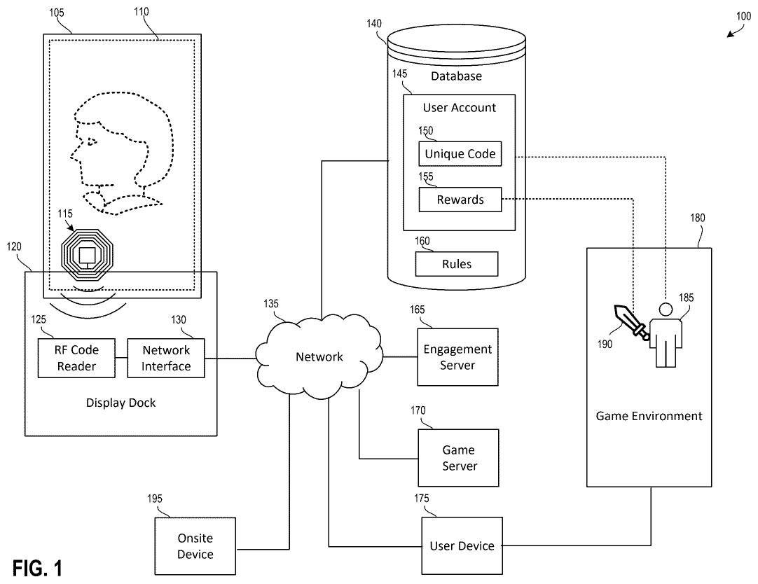

FIG. 1 illustrates an exemplary network environment 100 in which a system for tracking user engagement across real-world and digital environments may be implemented. Network environment 100 may include a physical collectible item 105 (e.g., card displaying content 110 and including an embedded code 115), display dock 120 (including code reader 125 and network interface 130), communication network 135, database 140 (storing a user account 145 associated with unique code 150 and digital rewards 155, as well as rules 160), engagement server 165, game server 170, user device 175 used to generate a game environment 180 that includes an avatar 185 and in-game object 190 based on data from user account 145 and digital rewards 155, and onsite device 195. Devices in network environment 100 may communicate with each other via communications network 135.

As illustrated, physical collectible item 105 may be shaped as a card constructed of any suitable material (e.g., paper-based materials, metal, plastic). A variety of other physical objects may be used, however, within the scope of the present disclosure that are not limited to the form factor of a card. For example, the physic physical collectible item 105 may include an action figure, a model, or any other portable physical object that is capable of presenting an embedded code to code readers (e.g., code reader 125). For ease of description, the physical object will be described hereafter as a physical collectible item 105, recognizing that the term can be more broadly construed.

In some embodiments, the physical collectible item 105 may be printed with or otherwise display content 110 (e.g., artwork) on the surface of the physical collectible item 105. The content 110 may be associated with a particular video game or other content title (e.g., a specific character, faction, location, scene, and/or item from the video game). In some embodiments, a set of cards 105 may be associated with a particular video game or gaming franchise. In certain implementations, the content 110 may be selected and/or provided by a purchaser of the physical collectible item 105.

The content 110 may be applied to the physical collectible item 105 using one or more of a variety of technologies, e.g., digital printing, which uses inkjet technology to create high-quality images directly on plastic; laser printing, which uses a high-powered laser to etch a design into the plastic; screen printing, which uses a stencil or mesh screen to transfer ink onto the plastic; UV litho printing, which uses ultraviolet light to cure or dry ink on a variety of surfaces; pad printing, which uses a silicone pad to transfer ink from an etched plate onto a 2D surface or 3D plastic object; flexo printing, which uses flexible photopolymer print forms for direct printing; and/or offset printing, which can produce high-quality prints on plastic and other substrates.

In some embodiments, the physical collectible item 105 includes a embedded code 115 (such as a QR code, bar code, or other code) printed on the surface of the physical collectible item 105 using a technique similar to or different from the content 110, encoded in an radio frequency identification (RFID) chip, NFC tag, Bluetooth® tag, or otherwise.

The physical collectible item 105 may be inserted into a handheld accessory, such as a display dock 120, which securely holds and displays the physical collectible item 105. The display dock 120 may include a code reader 206, which is capable of reading the embedded code 115 from the physical collectible item 105. For example, if the embedded code 115 is encoded into a radio frequency identification (RFID) tag, the code reader 125 may be an RFID reader, while if the embedded code 115 is a NFC or Bluetooth® tag, the code reader 125 may be an NFC or Bluetooth® tag reader, respectively. In some implementations, the display dock 120 may be part of or connectable to a portable user device 175, such as a smartphone or tablet. The smartphone or tablet may read the embedded code 115 using a built-in camera or NFC or Bluetooth® reader. The embedded code 115 may then be sent to the engagement server 160 via a cellular network and/or the Internet in the manner described above.

The code reader 125 may provide the embedded code 115 to a network interface 130, which is capable of sending the unique code to a engagement server 160 through communication network 135, including the Internet. The network interface 130 may implement any suitable protocol(s), e.g., IEEE 802.11x, LTE, TCP/IP. The engagement server 160 may then look up the embedded code 115 to identify a user account 145 stored in association with a matching unique code 150 in database 140. The user account 145 and/or database 140 may be associated with a gaming network, such as the PlayStation Network™ (PSN). In some configurations, the database 140 may be implemented using blockchain technology.

Communication network 135 may be a local, proprietary network (e.g., an intranet) and/or may be a part of a larger wide-area network. The communications network 110 may be a local area network (LAN), which may be communicatively coupled to a wide area network (WAN) such as the Internet. The Internet is a broad network of interconnected computers and servers allowing for the transmission and exchange of Internet Protocol (IP) data between users connected through a network service provider. Examples of network service providers are the public switched telephone network, a cable service provider, a provider of digital subscriber line (DSL) services, or a satellite service provider. Communications network 135 allows for communication between the various components of network environment 100.

Database 140 may be inclusive of local storage or storage distributed across multiple different servers, or on any of the devices (e.g., engagement server 165, game server 170, user device 175) in network environment 100. Database 140 may store data associated with a user account 145, including information about the user (e.g., user progress in an interactive online activity and/or media content title, user id, associated avatars and game characters, etc.) that may be associated with one or more media titles and engagement thereof over communication network 135. As illustrated, user account 145 may further be associated with a stored unique code 145 and information regarding digital rewards 155 earned by the user or to which the user is otherwise entitled to be access. Database 140 may further store rules 160 governing how real-world interactions may result in new digital rewards 155. Such rules 160 may specify different progress levels required to earn one or more of the digital rewards 155. For example, the rules may specify that a real-world interaction in which the user meets up with a peer user (who has their own unique code embedded in a respective physical collectible item) in a real-world environment may earn the user one type or amount of reward, while further real-world interactions with additional peer users may earn more or different rewards.

Such data in database 140 may be continually updated as a user continues to engage in new online interactive sessions and produce new session data regarding various interactions that have taken place within digital environments. In addition, database 140 may be updated based on real-world interactions that are associated with the embedded code 115, which may then be matched to the stored unique code 150. Such updates may also include updated rewards 155 that accrue to the user account 145 when the real-world interactions are determined to have occurred.

Network environment 100 may further include one or more engagement servers 165 and game servers 170. The servers described herein may include any type of server as is known in the art, including standard hardware computing components such as network and media interfaces, non-transitory computer-readable storage (memory), and processors for executing instructions or accessing information that may be stored in memory. The functionalities of multiple servers may be integrated into a single server. Any of the aforementioned servers (or an integrated server) may take on certain client-side, cache, or proxy server characteristics. These characteristics may depend on the particular network placement of the server or certain configurations of the server.

Engagement server 165 may include any data server known in the art that is capable of communicating over communication network 135 with the other devices in the network environment 100. Engagement server 165 may be implemented on one or more cloud servers that carry out instructions associated with the methods described herein. Engagement server 165 may further carry out instructions, for example, for matching codes embedded in signals received over communication network 135 to a unique code 150 stored in a particular user account 145 in database 140. The received signals may also be indicative of a real-world interaction with a peer user associated with their own user account.

Engagement server 165 may evaluate such indications of real-world interactions in conjunction with rules 160 to determine whether the particular user (associated with user account 145) has satisfied the requirements of one or more rewards. Where engagement server 165 determines that a set of requirements has been satisfied for a particular reward, the engagement server 165 may update the user account 145 to reflect the reward 155 is now available to the user. Such a digital reward or entitlement may be inclusive of digital content, skins, trophies, in-game resources, in-game abilities or ability enhancements, custom objects, etc. In some configurations, the embedded code 115 may unlock part or all of the digital environment (e.g., video game) itself.

Game server 170 (or interactive content server) may maintain and provide a variety of digital content and digital services (e.g., corresponding to different game titles) available for distribution over communication network 135. The game server 170 may be associated with any content provider that makes its digital content available for access over communication network 135 (e.g., streaming or download). Multiple different game servers 170 may therefore host a variety of different content titles (e.g., different video games), which may further have be associated with object data regarding a digital or virtual character or object displayed in a digital or virtual environment during an interactive session. Such content may include not only digital video and games, but also other types of digital applications and services. Such applications and services may include any variety of different digital content and functionalities that may be provided to user devices 175, including providing and supporting chat and other communication channels. The chat and communication services may be inclusive of voice-based, text-based, and video-based messages. Thus, a user device 175 may participate in a gameplay session concurrent with one or more communication sessions, and the gameplay and communication sessions may be hosted on the same or different game servers 170. In some implementations, game server 170 may communicate with database 140 in order to obtain information regarding specific users of user accounts 145 and to tailor in-game interactions to a specific user or sets of users in accordance with the user-specific data.

Users may use any number of different electronic user devices 175, such as general purpose computers, mobile phones, smartphones, personal digital assistants (PDAs), portable computing devices (e.g., laptop, netbook, tablets), desktop computing devices, handheld computing device, or any other type of computing device capable of communicating over communication network 135. User devices 175 may also be configured to access data from other storage media, such as memory cards or disk drives as may be appropriate in the case of downloaded services. User device 175 may include standard hardware computing components such as network and media interfaces, non-transitory computer-readable storage (memory), and processors for executing instructions that may be stored in memory.

In exemplary embodiments, user device 175 may stream and render interactive digital content from one or more online sources (e.g., game server 170). Thus, a digital, virtual environment such as game environment 180 may be presented to a user of user device 175 (e.g., via display accessory devices or display components). The user may control an avatar 185 within the game environment 180. Such an avatar 185 may be specific to the user and the particular content title being streamed and/or executed by user device 175. Some users may make extensive customizations to their avatar(s) 185, and such customizations may be stored by database 140 in association with the user account 145 of the user. Game server 170 and/or user device 175 may thus access database 140 in order to obtain and process such data for presentation within the game environment 180.

Similarly, in-game objects 190 and abilities and characteristics thereof may be associated with the user account 145 or more specifically, the rewards 155 accrued to the user account 145. For example, the game environment 180 may be a game environment, such as a role-playing game (RPG) title, in which the user is graphically represented by avatar 185. The embedded code 115 may be associated with a real-world action that satisfies the requirements for unlocking a digital reward 155 (e.g., such as an in-game sword or other weapon), which may then be stored to user account 145 and provided to the user's avatar 185 during a next gameplay session. In some embodiments, when the embedded code 115 is associated with the user's account 214, the reward 155 becomes permanently or temporarily unlocked for use by the user within the game environment 180. In other embodiments, the reward 155 is unlocked as long as the physical collectible item 105 is docked, i.e., removal of the physical collectible item 105 from the display dock 120 may remove and/or re-lock the reward 155 for the user within the game environment 180.

Onsite device 195 may include kiosks, scanning devices, or other reading devices located at a specified geographic location. Onsite device 195 may detect, scan, or read the embedded code 115 when the user—carrying the physical collectible item 105—within range. In some embodiments, the associated display dock 120 or user device 175 may also communicate with onsite device 195 to assist with location detection and sharing in accordance with permissions and settings of the user. In some implementations, onsite devices 195 may include any device with location awareness components such as global positioning system (GPS) chips, which may further be used to detect and communication location information along a unique code over communication network 135 to engagement server 165.

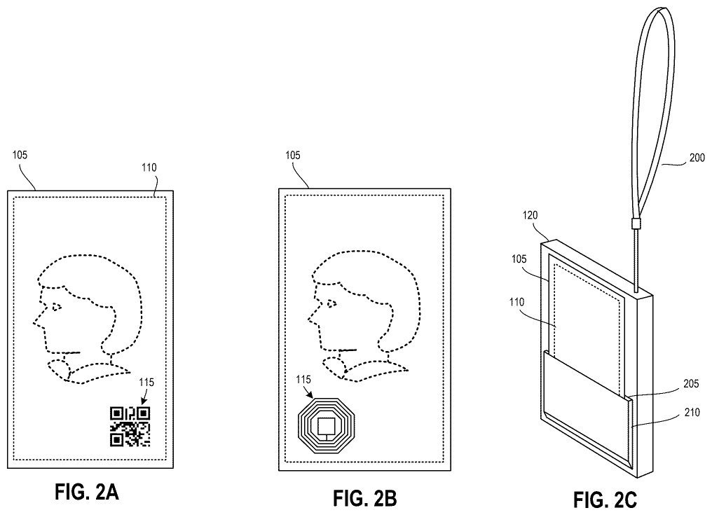

FIGS. 2A-C illustrate exemplary physical collectible items 105 that may be used to track user engagement across real-world and digital environments. As shown in FIG. 2A, the embedded code 115 may be printed in the form of a quick response (QR) code, which is a type of two-dimensional matrix barcode. However, any kind of human-readable text or machine-readable barcode may be used to represent the embedded code 115 on the physical collectible item 105. In some embodiments, the unique code may be a GUID (globally unique identifier), which is a 128-bit text string that can uniquely identify the physical collectible item 105. The embedded code 115 may include a unique code that may be matched to a user account 145 (of FIG. 1) of a specific user (e.g., the owner or bearer of the physical collectible item 105).

Alternatively, as shown in FIG. 2B, the embedded code 115 may be embedded or stored within a radio frequency tag, such as a radio frequency identification (RFID) tag. RFID tags are small devices that use radio waves to identify, track, and communicate with objects. They can store a variety of information, such as serial numbers, short descriptions, and other data. Some RFID tags also have cryptographic security features for authentication and verification. The RFID tag may include a memory device to store the embedded code 115, as well as an antenna for communicating with and/or receiving power from a reader device. A variety of technologies besides RFID may be used, such as near field communication (NFC) and/or Bluetooth.

FIG. 2C illustrates an implementation in which the physical collectible item 105 may be inserted and carried within a portable display dock 120, which additionally includes a strap 200 or lanyard for easy carrying and a slot 205 into which the physical collectible item 105 may be inserted into a receptacle 210. The slot 205 and/or the receptacle 210 are configured (e.g., provided suitable length, width, depth, materials, and/or securing mechanisms) to securely and releasably hold the physical collectible item 105 (e.g., card) when docked by means of friction and/or gravity. A proximal face of the receptacle 210 (i.e., a portion of the receptacle facing away from the display dock 120) may be transparent so as to not obscure the artwork 110 printed on the physical collectible item 105. Alternatively, the depth of the receptacle 210 may be sufficiently shallow so as to not obscure the artwork 110 on the card 105 while still securely holding the card 105. The display dock 120 may be constructed from any suitable material, such as plastic (e.g., PET, HDPE, PVC, LDPE, PP, PC), metal, glass, or Plexiglass® (acrylic).

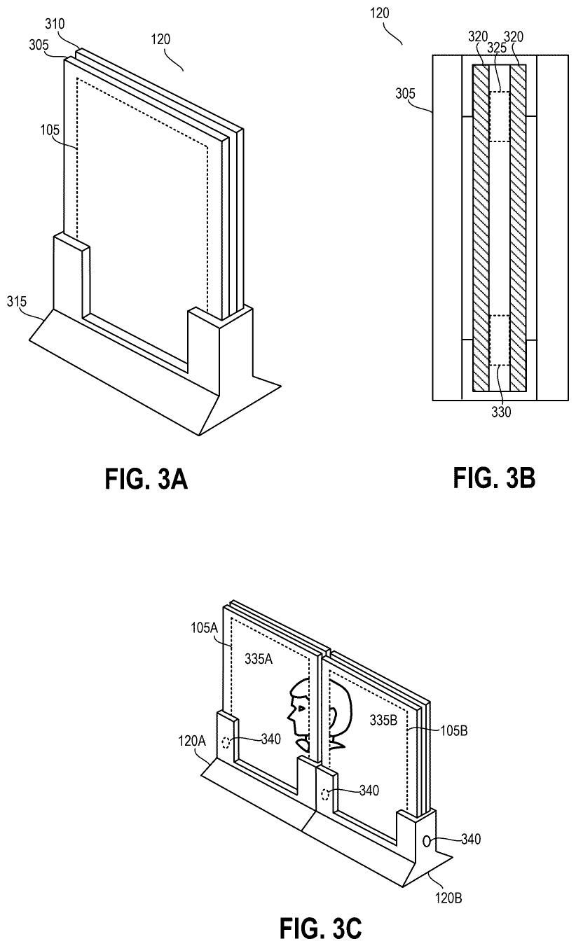

FIGS. 3A-B illustrate an exemplary configuration of a dock 120 used to display content 110 associated with physical collectible items 105. FIG. 3A illustrates a configuration of the display dock 120 suitable for displaying the physical collectible item 105 on a desk or shelf in an upright orientation. The display dock 120 of FIG. 3A includes a viewing (front) layer 305 and a backing layer 310. At least the viewing layer 305 may be transparent to allow the physical collectible item 105 to be viewed through the viewing layer 305. The distance between the viewing layer 305 and the backing layer 310 may be sufficient to securely and releasably hold the physical collectible item 105 between the layers 305-310 by friction and/or gravity.

The display dock 120 may further include a base component 315 sized to receive and securely hold the viewing layer 305 and the backing layer 310 at a predetermined distance. As illustrated in the top-down view of FIG. 3B, the base component 315 may include slots 320 and/or spacers 325 to hold the viewing layer 305 and backing layer 310 at the predetermined distance. In other configurations, the viewing layer 305 and backing layer 310 may form the front and rear portions of a transparent receptacle 210 that encloses the physical collectible item 105 on at least four sides.

FIG. 3C illustrates an exemplary implementation in which multiple display docks 120A-B may be aligned together and side-by-side. Each display dock 120A-B may hold a respective physical collectible item 105A-B, each of which may have an respective display 335A-B, respectively. In one embodiment, the integrated displays 335A-B of the two cards 105A-B may operate in concert to extend an image over both integrated displays 335A-B, effectively doubling the display area of a single integrated display that results from aligning displays 335A-B. Such an extension of the display area may be accomplished by the respective display controllers of each physical collectible item 105A-B.

In some embodiments, each display dock 120A-B may have one or more proximity sensors 340, such that when the proximity sensor 340 of one display dock 120A is touching or close to the proximity sensor 340 of another display dock 120B, the display controllers of the respective cards 105A-B are automatically configured to extend an image over both integrated displays 335A-B as if they were a single integrated display. Of course, the integrated displays 335 of three (or more) cards 105 may be combined and/or extended when their respective display docks 120 are placed side-by-side allowing for increasingly large display areas.

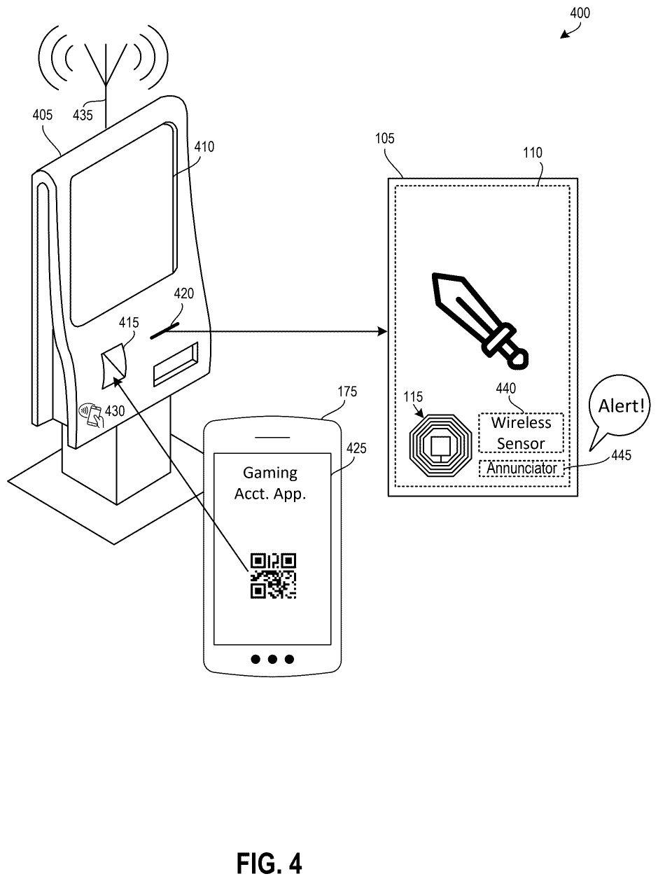

FIG. 4 illustrates an exemplary kiosk 405 where physical collectible items 105 may be obtained and registered with user accounts 145. Such a kiosk 405 may hold a number of new cards 105 that have been pre-printed with various artwork 110 associated with one or more video games. The kiosk 405 may include a touch-sensitive display 410 or other input/output component capable of displaying text, graphics, and video, and receiving user selections in response to the user selection of various graphical elements. The user may authenticate with the kiosk 405 by providing a user name and password via the touch-sensitive display 410.

Alternatively, the user may have previously authenticated with a gaming account application 425 (e.g., PSN application) running on a portable user device 175, such as a smart phone. Upon being authenticated on the user device 175, the gaming account application 425 may display a QR code, which may be read by a code scanner 415 (e.g., camera or laser scanner) within the kiosk 405. In other embodiments, the portable user device 175 may communicate with the kiosk 405 using a wireless communication technique, such as WiFi, NFC, or Bluetooth.

The user may then operate the touch-sensitive display 410 to view available cards 105 and/or entitlements. Some cards 105 may be pre-associated with unique codes 115 and particular entitlements, such as items, skins, or the like. Other cards 105 may have no pre-associated entitlements, and a user may select, via the touch-sensitive display 410, one or more entitlements to purchase and associate with a desired physical collectible item 105. By means of the touch-sensitive display 410, the user may also watch trailers or other descriptive videos or text describing the purchase options.

As an example, a user may wish to obtain a reward or entitlement 155, such as a particular sword for a video game that the user owns. The user selects a physical collectible item 105 having artwork 110 depicting the sword. The physical collectible item 105 may have been pre-associated with a embedded code 115 that, when added to the user account 145 of the authenticated user, will provide the sword to the user's character 185. Assuming that the kiosk 405 has a physical collectible item 105 in its inventory with the desired artwork 110, the kiosk 405 may retrieve the physical collectible item 105 and verify the embedded code 115 using a code reader (not shown) as described in connection with FIG. 1. Thereafter, the kiosk 405 may transmit the embedded code 115 to the engagement server 160 via the communication network 135, such that the embedded code 115 is stored as unique code 150 associated with the user account 145, as previously described, or the user is associated with the embedded code 115, i.e., the embedded code 115 becomes an account number or identifier to represent the user. The kiosk 405 may then issue the physical collectible item 105 to the user via a vending slot 420.

In some implementations, the user may already own a physical collectible item 105 depicting a character from a particular video game and want to register for a live, real-world event and/or associate a new reward, such as an in-game object, with the physical collectible item 105. In such an embodiment, the user may insert the physical collectible item 105 into the vending slot 420 and/or tap the physical collectible item 105 on a tap sensor 430, where the embedded code 115 is read. The user may then select the event or reward to be associated with the embedded code 115 and authenticate themselves in the same manner described herein. The primary difference is that a new physical collectible item 105 is not issued to the user. Rather, the user's physical collectible item 105, or more specifically, the embedded code 115 associated with the user's physical collectible item 105, is associated in the database 140 with the event registration and any associated rewards 155 (updated with any newly earned or purchased rewards or entitlements).

In some implementations, the physical collectible item 105, the display dock 120, or user device 175 may include a wireless sensor 440 and/or an annunciator 445. The wireless sensor 440 detects the proximity of a wireless transmitter 435 in the local environment as the user carries the docked physical collectible item 105. The annunciator 445 audibly or haptically notifies the user of the proximity of the wireless transmitter 435. Alternatively, or in addition, the integrated display 110 may function as an annunciator, graphically indicating that the wireless transmitter 435 is near. In some embodiments, the wireless sensor 440 may be implemented using the code reader 125 or the network interface 130 of the display dock 120, either of which may be configured to detect the existence (and strength) of certain RF signals.

As an example, the wireless transmitter 435 may be a Bluetooth® transmitter deployed in a kiosk 405. As the user moves about the local environment, the wireless sensor 440 (or code reader 125 or network interface 130) detects an RF transmission from the wireless transmitter 435. The content of the RF transmission may indicate that the detected wireless transmitter 435 is associated with a nearby kiosk 405. As a result, the physical collectible item 105 may be programmed to display a message, e.g., “ALERT: Kiosk nearby!” Alternatively or in addition, the annunciator 445 may be programmed to deliver a haptic response (vibration) or audible message (including a spoken message in some cases), notifying the user of the existence of the nearby kiosk 405.

As another example, the aforementioned components may be used to alert the user to the proximity of nearby friends, each of whom may be carrying docked cards 105, which may have been obtained from or registered with kiosk 405. For example, the network interfaces 130 of each friend's display dock 120 may serve as wireless transmitters 435. As the user moves about the local environment, the wireless sensor 440 (or code reader 125 or network interface 130) detects an RF transmission from the wireless transmitters 435 (or network interfaces 130). The RF transmission may include a code that identifies the owners of the respective cards 105. If one of the owners is a friend of the user, the user's physical collectible item 105 may be programmed to display a message, e.g., “ALERT: Friend nearby!” Alternatively or in addition, the annunciator 445 may be programmed to deliver a haptic response (vibration) or audible message (including a spoken message in some cases), notifying the user of the existence of the nearby friend.

Alternatively, the aforementioned components may be used in the context of a scavenger hunt, at a convention (e.g., ComicCon™), or in other ways where it is necessary or useful to alert the user to the existence of an item, person, or information in their vicinity marked by respective wireless transmitters 435. In some embodiments, the user may receive achievements or trophies or certain rewards 155 in response to visiting a real-word location marked by a wireless transmitter 435, which could be reflected on the display 110 of the physical collectible item 105. In some implementations, the respective user devices 175 of each user and peer/friend may serve to perform one or more functions of the wireless transmitter 435, as well as wireless sensor 440 and annunciator 445, as described herein.

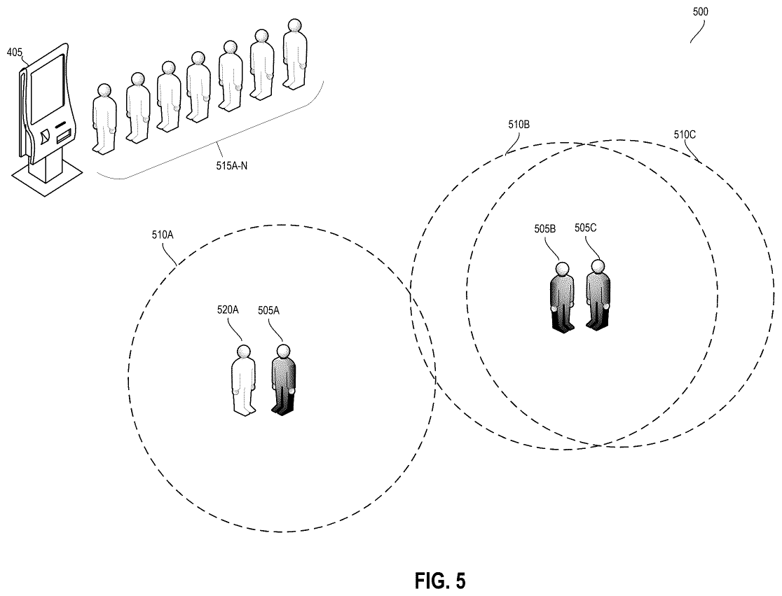

FIG. 5 illustrates an exemplary real-world environment 500 in which a system for tracking user engagement across real-world and digital environments may be implemented. Within real-world environment 500, some users 505A-C may have already obtained physical collectible items 105 and/or otherwise registered for user accounts 145 (and thus assigned respective unique codes 150), which allows for interactions within real-world environment 500 to be tracked and stored in their respective user accounts 145. Each user 505A-C may thus be associated with a respective range of awareness 510A-C corresponding to the capabilities of their respective physical collectible items 105, display dock 120, or other user device 175.

The range of awareness 510A-C define a proximity within which other registered users may be detected, thus triggering notifications to be generated and displayed on their respective physical collectible items 105, display dock 120, or user device 175. Such a notification may thus provide a prompt for the registered users to find and interact with each other in the real-world environment 500. Registered users 505B and 505C, for example, may have been notified to each other's presence within their respective ranges of awareness 510B and 510C. Meanwhile, unregistered users 515A-N may not yet have been issued their own respective physical collectible items 105, nor assigned their own respective unique codes 150, nor registered for the event taking place within real-world environment 500. The unregistered users 515A-N may obtain or otherwise register their physical collectible items 105, however, at kiosk 405.

Meanwhile, user 505A is associated with range of awareness 510A, which overlaps with range of awareness 510B but not with range of awareness 510C. Thus, registered user 505A may only receive notification that user 505B was detected within the specified proximity, but not notified with respect to user 505C. Notwithstanding, user 505A may interact with other, unregistered users such as user 520A. While user 520A may not have been registered for the event, however, user 520A may nevertheless have their own respective user account 145 and unique code 150. Some implementations may allow for real-world interactions to be tracked using a gaming app 425, which allow for interactions involving user 520A to be associated with their respective unique code and thus qualify for rewards 155 in accordance with associated rules 160.

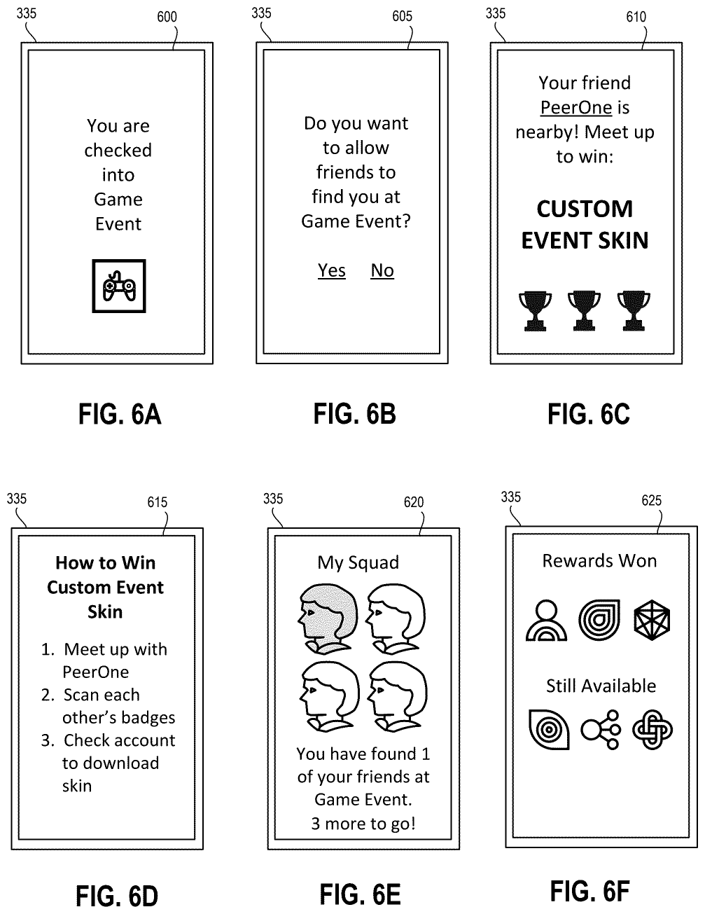

FIGS. 6A-F illustrate exemplary screenshots of graphical user interfaces (GUIs) 600-625 that may be presented on a display 335 as user engagement is tracked across real-world and digital environments. Such GUIs 600-625 may be presented by a user's respective display 335 of display dock 120 (or user device 175) once their respective physical collectible item 105 has been obtained and their respective unique code 150 registered with and stored in relation to their respective user account 145. The users may also opt to allow their respective friends and peers (e.g., per stored user account 145 data) to be notified of their real-world proximity on a short-term, temporary or ongoing basis.

FIG. 6A illustrates a GUI 600 that may be presented when a user has obtained their physical collectible item 105 and checked into an event (e.g., gaming convention) in a real-world environment 500. GUI 600 may include event branding and associated display content, as well as allow for access to information regarding the event.

FIG. 6B illustrates a GUI 605 that may be presented when the user is allowed to opt in or opt out of allowing their friends and peers to detect their presence in the real-world environment 500. Each user may be permitted to specify their own privacy settings in relation to location sharing, but may also be informed as to various rewards, incentives, and entitlements that may be earned, won, or otherwise obtained based on real-world interactions, which may be facilitated through location sharing.

FIG. 6C illustrates a GUI 610 that may be presented when a user is notified as to the presence of a friend or peer within a predetermined proximity (e.g., range of awareness 510 corresponding to device capabilities of wireless sensor 440). GUI 610 may identify the particular friend or peer that is detected, as well as identify an available reward 155 if the user were to find and interact with the detected friend or peer in the real-world environment 500.

FIG. 6D illustrates a GUI 615 that may be presented when the user seeks to satisfy the requirements of earning the reward 155. GUI 615 may provide instructions for how the reward 155 is to be earned and obtained. Such instructions may be based on stored rules 160 associated with the particular reward 155 being offered by FIG. 6C.

FIG. 6E illustrates a GUI 620 that may be presented when the user is determined to have interacted with a subset of their peers. GUI 620 may be generated based on user account 145 data regarding the user's friends and peers with whom the user may have interacted in digital environments (e.g., during online gameplay sessions) in relation to one or more interactive content titles. The list of friends or peers may be filtered based on the context of the event (e.g., esports tournament for specific game title or titles) or based on how many friends or peers are registered to attend the event.

FIG. 6F illustrates a GUI 625 that may be presented when the user is determined to have earned or won certain rewards, while other rewards remain outstanding and yet to be won. GUI 625 may be updated in real-time as the user earns additional rewards based on associated requirements being satisfied by the user's real-world interactions as specified by stored rules 160.

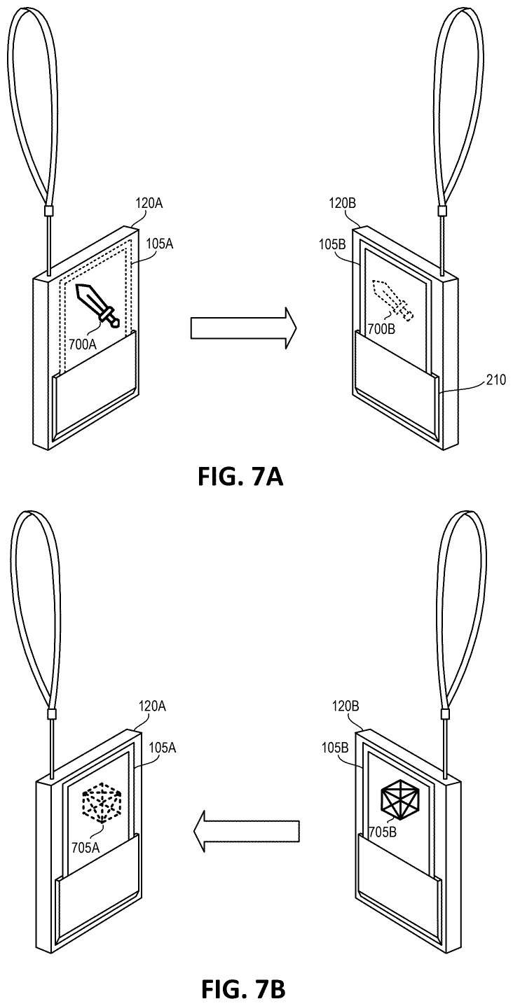

FIGS. 7A-B illustrate exemplary exchanges of digital content between two user devices. In particular, FIG. 7A illustrates the transfer of digital content 700A associated with physical collectible item 105A and display dock 120A to physical collectible item 105B and display dock 120B. Such transfer may be accomplished by physically transferring the physical collectible item 105A from the first display dock 120A to the second display dock 120B. The second display dock 120B may receive the inserted physical collectible item 105A into the receptacle 210. The embedded code 115 of the physical collectible item 105A may be read by the second display dock 120B and sent to the engagement server 160, where it is associated with the second user account 145 (e.g., associated with the display dock 120B) in the database 140 and stored therein. The digital content 700A—which may be or associated with a digital reward 155—may thus be copied and stored as digital content 700B in association with the second user account 145. For example, the digital content 700B may include an in-game sword associated with a particular game title, which may therefore be used by the second user account 145 (e.g., via associated avatar 185) within a virtual environment 180 of that game title during a next gameplay session.

In some configurations, the first user may be prompted via, e.g., a text or email message, to approve the copying of the content 700A to the second user account 145. In other configurations, the first user may approve the copying of the content 700A using an interface displayed on the physical collectible item 105A, which may include providing a password or PIN. For example, the physical collectible item 105 and any associated reward 155 may be locked to prevent theft of the rewards 155 or content 700A if the physical collectible item 105 is lost or stolen. Providing the password or PIN, for example, may allow the rewards 155 or content 700A to be transferred to the second user with the physical transfer of the physical collectible item 105A.

FIG. 7B illustrates a transfer by the second user of digital content 710 associated with a second physical collectible item 105B to the first physical collectible item 105A owned by the first user. In some implementations, a physical transfer of cards 105 may not be required. Instead, the user of the second physical collectible item 105B may approve a transfer in a dialogue displayed on the second display 335. The second physical collectible item 105B may be identified, for example, by bringing the second card 105 and/or second display dock 120B in proximity to the first physical collectible item 105A and/or the first display dock 120A. The wireless sensor 440 (or the code reader 125 or network interface 130) associated with the first user may detect the proximity of the second user's physical collectible item 105B and/or display dock 120B and determine the account 145 of the second user. In some embodiments, this may be accomplished by tapping the first and second cards 105A and 105B, or the first and second display docks 120A and 120B.

In response, the embedded code 115 of the physical collectible item 105B is sent to the engagement server 160 and associated with the first user's account 145 in the database 140, unlocking the content 700B for the first user. Such exchanges or sharing between users allow for a single physical collectible item 105 to be associated with multiple digital content files. Certain media titles may be associated with multiple different pieces of digital artwork, which may be distributed for collecting by fans and users through the physical collectible item 105. As a user meets and interacts with their peers in the real-world, that user may also add additional pieces of artwork to their collection.

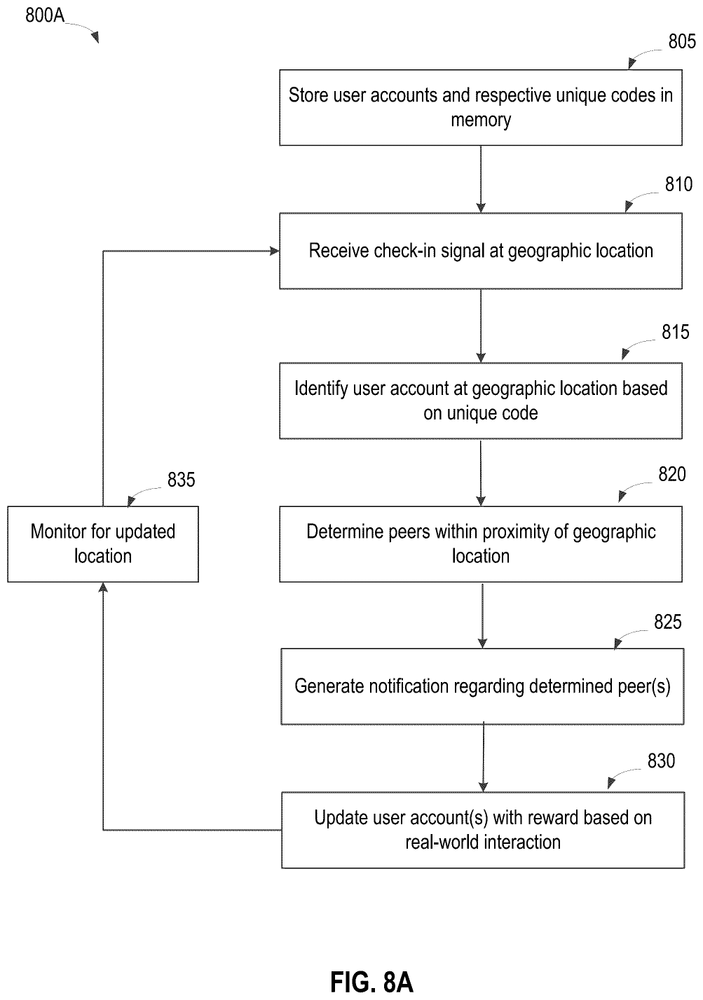

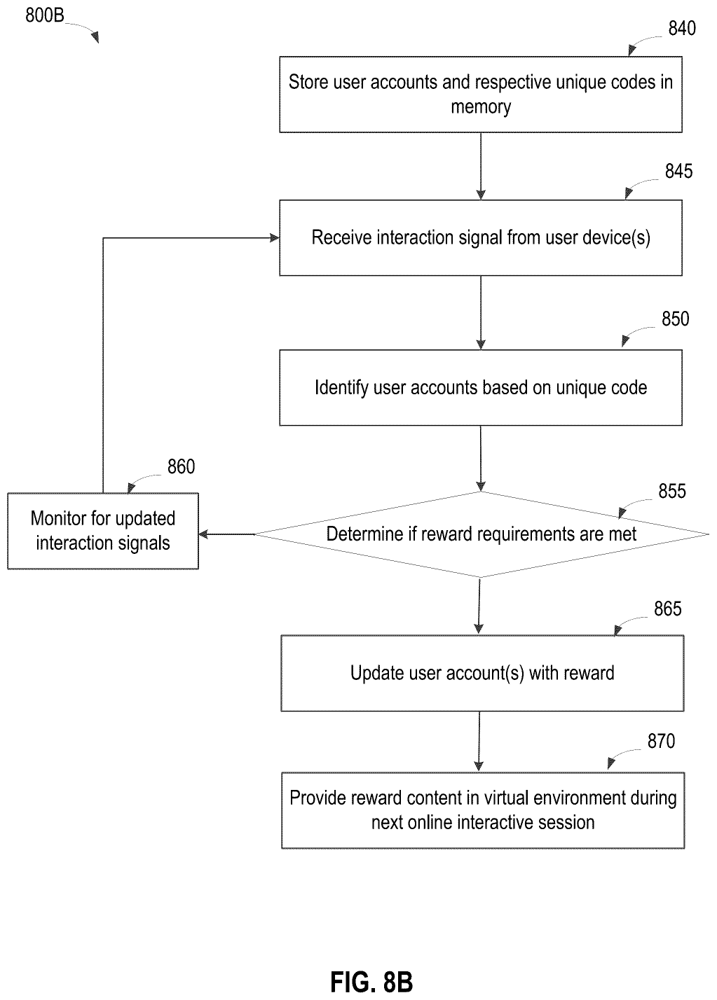

FIGS. 8A-B are flowcharts illustrating exemplary methods 800A-B for tracking user engagement across real-world and digital environments. The methods 800A-B of FIGS. 8A-B may be embodied as executable instructions in a non-transitory computer readable storage medium including but not limited to a CD, DVD, or non-volatile memory such as a hard drive. The instructions of the storage medium may be executed by a processor (or processors) to cause various hardware components of a computing device hosting or otherwise accessing the storage medium to effectuate the method. The steps identified in FIGS. 8A-B (and the order thereof) are exemplary and may include various alternatives, equivalents, or derivations thereof including but not limited to the order of execution of the same.

FIG. 8A is a flowchart illustrating an exemplary method for tracking user engagement across real-world and digital environments. Method 800A of FIG. 8A may be performed when a user is notified that a peer is within a proximity in the real-world environment 500 and interaction therewith is associated with a digital reward. Method 800A begins with step 805 in which user accounts 145 are stored in a database 140 in memory. A user account 145 may be updated to include stored information regarding a unique code 150 assigned to the user of the user account 145 when the user obtains and registers a physical collectible item 105. Registration allows for the embedded code 115 of the physical collectible item 105 to be provided to database 140 for storage in association with the user account 145 that is also used to engage in gameplay on online gaming platforms (e.g., including one or more game servers 170).

In step 810, a check-in signal may be received by engagement server 165 from a device at geographic location. Such check-in signal may be sent from a kiosk 405 from which the user obtained or otherwise registered the physical collectible item 105 for usage and rewards accumulation within the real-world environment 500. Where the real-world environment 500 is a fan event or game convention that provides custom content as rewards, for example, the user may be incentivized to check-in to quality for such rewards. Such signal may also be a permission for engagement server 165 to track location data associated with the user and user account 145 for processing rewards based on associated real-world interactions.

In step 815, the engagement server 165 may identify the user account 145 associated with the check-in signal based on inclusion of the unique code. Thus, a particular user 505A of a particular user account 145 may be identified as being present at the geographic location of the real-world environment 500. Such information may also be stored in association with user account 145 and considered in relation to rewards requirements in accordance with stored rules 160 (e.g., where current presence may be a requirement or otherwise contribute towards earning a reward).

In step 820, the engagement server 165 may retrieve data from user account 145 regarding friends and peers with whom the user has interacted during online gameplay sessions. The friends or peers may also have registered and checked-in with engagement server 165 and thus present at the same event at the geographic location, as well as also opted into location sharing. As the users'respective physical collectible items 105, display docks 120, and user devices 175 come into proximity of each other, their proximity may be identified as being associated with their respective unique code, which may be looked up by engagement server 165. Thus, the particular peer users located within the proximity may be determined.

In step 825, a notification may be generated regarding the peer users identified as being within the proximity. Such notification may be generated and sent to display dock 120 or user device 175 for presentation to the user. The notification may include an identification of the particular identified peer users, as well as information regarding available rewards for interacting with the peer user in the real-world environment 500. For example, the notification may further specify that the requirements of the real-world interaction for earning a reward, as well as instructions for the same.

In some instances, the rewards may require a series of steps, and the user may have made partial progress. The notification may also identify which requirements may be achieved within the proximity and which progress levels may be achieved therefrom. Some implementations include associating different peers with different requirements that may be met and thus different progress levels that may be achieved by interacting with each different peer. For example, each different peer may be associated with different digital content 700 that need to be collected by the user in order to earn rewards. The notification may thus identify which peer and/or which digital content are within the proximity. The different digital content 700 may each also be associated with different in-game abilities and advantages when used within the next gameplay session.

In step 830, the engagement server 165 may receive indications that a real-world interaction has take place in association with the user account 145 and may update the user account 145 accordingly. The indications may include interaction signals from one or more of the user device associated with the identified user account and a user device associated with the at least one peer indicating the real-world interaction. The real-world interaction may include mutual exchange and scanning of each other's physical collectible item 105, connection of one's own display dock to the display dock of the peer, exchange of digital content 700, or other physical, real-world interaction specified by the stored rules 160.

Some implementations may further weight real-world interactions based on how influential a user is in causing their direct peers and downstream peers (e.g., friends of friends) to attend and engage in the real-world setting. For example, the user may invite their online friends to a real-world event, and the online friends may pass on the invitation to their own friends, and so on. The user may be identified as the head of an extensive series of downstream invitations, as well as actual participants. Thus, a user account 145 may be associated with a series of downstream peers, and the progress level may be weighed (and additional rewards achieved) based on the downstream peers.

Some events may take place of multiple days and locations. Thus, in step 835, engagement server 165 may monitor for updated location data for user accounts 145, as well as monitor for interaction data used to update progress levels and rewards status. As such, the method may revert back to step 810 when new check-in signals that include unique codes are received from onsite devices associated with a specific geographic location.

FIG. 8B is a flowchart illustrating an alternative method for tracking user engagement across real-world and digital environments. Method 800B of FIG. 8B may be performed to determine whether requirements associated with a reward are satisfied. The method 800B begins with step 840, which is the same as described in relation to step 805 of step 800A.

In step 845, one or more interaction signals may be received from one or more user devices, which may be inclusive of physical collectible item 105, display dock 120, or user device 175 associated with a particular user. The interaction signal may include not only the unique code of the user owning such devices, but also a scan or read of an embedded code 115 from a physical collectible item 105 belonging to a peer. Such an interaction signal may be generated, for example, when the user inserts physical collectible item 105B of a peer into their own display dock 120, which reads the embedded code 115 therefrom.

In step 850, the user accounts 145 may be identified by engagement server 165 from the specified unique codes 145 in the received interaction signals, and in step 855, it is determined whether any rewards requirements are met by the real-world interaction indicated by the interaction signals. For example, if the user has already interacted with the peer, no further rewards may be available, and the method may proceed to step 860 in which the engagement server 165 may monitor for updated interaction signals.

If rewards requirements are determined to have been met, the method may proceed In step 865 where the respective user accounts 145 of the user and peer may be updated to reflect the reward 155. For example, the user and peer may be rewarded with a custom, special edition, or limited edition skin associated with the event.

In step 870, the rewards content may be provided for use by the user account 145 of the user within a virtual environment 180 during a next gameplay session. For example, the special edition skin may be provided in an inventory of the associated game title when the user launches gameplay, and upon selection, the special edition skin may be applied to the avatar 185 or in-game object associated with the user and displayed to other players in the launched (multiplayer) gameplay session.

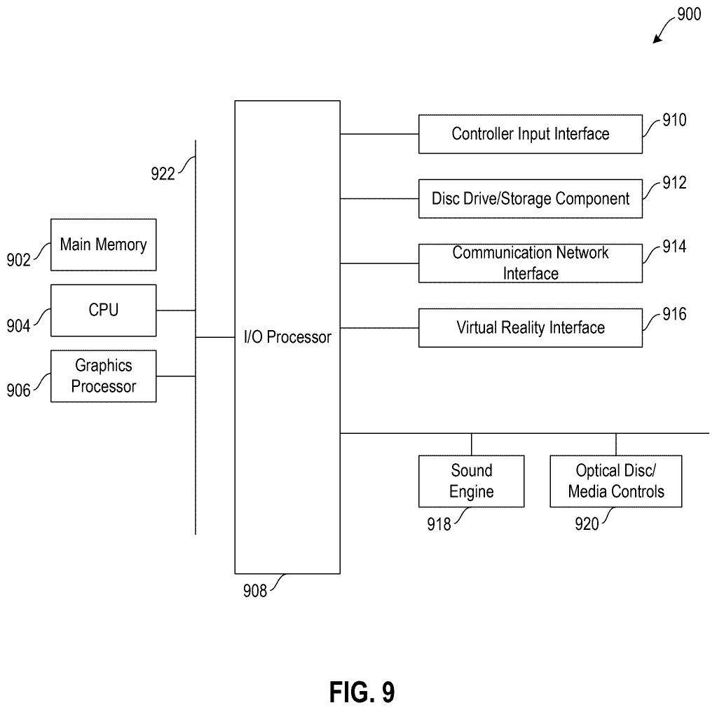

FIG. 9 illustrates a block diagram of an exemplary electronic entertainment system 900, which may be used to display and navigate the digital environment (e.g., game environment) shown in FIG. 2. The electronic entertainment system 900 as illustrated in FIG. 9 includes a main memory 902, a central processing unit (CPU) 904, graphic processor 906, an input/output (I/O) processor 908, a controller input interface 910, a hard disc drive or other storage component 912 (which may be removable), a communication network interface 914, a virtual reality interface 916, sound engine 918, and optical disc/media controls 920. Each of the foregoing are connected via one or more system buses 922.

Electronic entertainment system 900 as shown in FIG. 9 may be an electronic game console. The electronic entertainment system 900 may alternatively be implemented as a general-purpose computer, a set-top box, a hand-held game device, a tablet computing device, or a mobile computing device or phone. Electronic entertainment systems may contain some or all of the disclosed components depending on a particular form factor, purpose, or design.

Main memory 902 stores instructions and data for execution by CPU 904. Main memory 902 can store executable code when the electronic entertainment system 900 is in operation. Main memory 902 of FIG. 9 may communicate with CPU 904 via a dedicated bus. Main memory 902 may provide pre-stored programs in addition to programs transferred through the I/O processor 908 from hard disc drive/storage component 912, a DVD or other optical disc (not shown) using the optical disc/media controls 920, or as might be downloaded via communication network interface 914.

The graphics processor 906 of FIG. 9 (or graphics card) executes graphics instructions received from the CPU 904 to produce images for display on a display device (not shown). The graphics processor 906 of FIG. 9 may transform objects from three-dimensional coordinates to two-dimensional coordinates, and vice versa. Graphics processor 906 may use ray tracing to aid in the rendering of light and shadows in a game scene by simulating and tracking individual rays of light produced by a source. Graphics processor 906 may utilize fast boot and load times, 4K-8K resolution, and up to 120 FPS with 120 hz refresh rates. Graphics processor 906 may render or otherwise process images differently for a specific display device.

I/O processor 908 of FIG. 9 may also allow for the exchange of content over a wireless or other communications network (e.g., IEEE 802.x inclusive of Wi-Fi and Ethernet, 9G, 4G, LTE, and 3G mobile networks, and Bluetooth and short-range personal area networks). The I/O processor 908 of FIG. 9 primarily controls data exchanges between the various devices of the electronic entertainment system 900 including the CPU 904, the graphics processor 906, controller interface 910, hard disc drive/storage component 912, communication network interface 914, virtual reality interface 916, sound engine 918, and optical disc/media controls 920.

A user of the electronic entertainment system 900 of FIG. 9 provides instructions via a controller device communicatively coupled to the controller interface 910 to the CPU 904. A variety of different controllers may be used to receive the instructions, including handheld and sensor-based controllers (e.g., for capturing and interpreting eye-tracking-based, voice-based, and gestural commands). Controllers may receive instructions or input from the user, which may then be provided to controller interface 910 and then to CPU 904 for interpretation and execution. The instructions may further be used by the CPU 904 to control other components of electronic entertainment system 900. For example, the user may instruct the CPU 904 to store certain game information on the hard disc drive/storage component 912 or other non-transitory computer-readable storage media. A user may also instruct a character in a game to perform some specified action, which is rendered in conjunction with graphics processor 906, inclusive of audio interpreted by sound engine 918.

Hard disc drive/storage component 912 may include removable or non-removable non-volatile storage medium. Saud medium may be portable and inclusive of digital video disc, Blu-Ray, or USB coupled storage, to input and output data and code to and from the main memory 902. Software for implementing embodiments of the present invention may be stored on such a medium and input to the main memory via the hard disc drive/storage component 912. Software stored on a hard disc drive may also be managed by optical disk/media control 920 and/or communications network interface 914.

Communication network interface 914 may allow for communication via various communication networks, including local, proprietary networks and/or larger wide-area networks such as the Internet. The Internet is a broad network of interconnected computers and servers allowing for the transmission and exchange of Internet Protocol (IP) data between users connected through a network service provider. Examples of network service providers include public switched telephone networks, cable or fiber services, digital subscriber lines (DSL) or broadband, and satellite services. Communications network interface allows for communications and content to be exchanged between the various remote devices, including other electronic entertainment systems associated with other users and cloud-based databases, services and servers, and content hosting systems that might provide or facilitate game play and related content.

Virtual reality interface 916 allows for processing and rendering of virtual reality, augmented reality, and mixed reality data. This includes display devices such that might be partial or entirely immersive virtual environments. Virtual reality interface 916 may allow for exchange and presentation of immersive fields of view and foveated rendering in coordination with sounds processed by sound engine 918 and haptic feedback.

Sound engine 918 executes instructions to produce sound signals that are outputted to an audio device such as television speakers, controller speakers, stand-alone speakers, headphones, or other head-mounted speakers. Different sets of sounds may be produced for each of the different sound output devices. This may include spatial or three-dimensional audio effects.

Optical disc/media controls 920 may be implemented with a magnetic disk drive or an optical disk drive for storing, managing, and controlling data and instructions for use by CPU 904. Optical disc/media controls 920 may be inclusive of system software (an operating system) for implementing embodiments of the present invention. That system may facilitate loading software into main memory 902.

The systems and methods described herein can be implemented in hardware, software, firmware, or combinations of hardware, software and/or firmware. In some examples, systems described in this specification may be implemented using a non-transitory computer readable medium storing computer executable instructions that when executed by one or more processors of a computer cause the computer to perform operations. Computer readable media suitable for implementing the control systems described in this specification include non transitory computer-readable media, such as disk memory devices, chip memory devices, programmable logic devices, random access memory (RAM), read only memory (ROM), optical read/write memory, cache memory, magnetic read/write memory, flash memory, and application-specific integrated circuits. In addition, a computer readable medium that implements a control system described in this specification may be located on a single device or computing platform or may be distributed across multiple devices or computing platforms.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claims.

What is claimed is:

1. A method for tracking multi-user engagement across real-world and digital environments, the method comprising:
storing information in memory regarding a plurality of user accounts associated with different users, wherein the information regarding each of the user accounts includes data regarding interactions within a digital environment and a unique code that is also embedded in a physical item, and wherein the interactions are associated with one or more peers of a respective user;
receiving a check-in signal over a communication network from a network device associated with a specified geographic location at a current point in time;
identifying that the signal includes the unique code associated with an identified one of the user accounts;
determining that at least one of the peers of the user associated with the identified user account are also at the specified geographic location within an interval of the current point in time; and
generating a notification that identifies the at least one peer determined to be at the specified geographic location, the notification generated to be displayed on a user device associated with the identified user account.

2. The method of claim 1, further comprising updating the stored information regarding the identified user account to reflect current presence at the specified geographic location associated with the network device.

3. The method of claim 1, further comprising generating a notification that identifies that the user associated with the identified user account is at the specified geographic location, the notification generated to be displayed on a user device associated with the at least one peer.

4. The method of claim 1, further comprising receiving one or more interaction signals from one or more of the user device associated with the identified user account and a user device associated with the at least one peer indicating a real-world interaction.

5. The method of claim 4, further comprising updating the stored information regarding the identified user account to reflect the real-world interaction.

6. The method of claim 4, wherein the interaction signals are received from a plurality of user devices of a plurality of peers of the user of the identified user account, the plurality of peers being further associated with a series of one or more upstream peers, and further comprising updating the identified user account to include the plurality of peers and the series of upstream peers.

7. The method of claim 4, further comprising identifying that the real-world interaction corresponds to a progress level towards one or more digital rewards.

8. The method of claim 7, wherein the progress level is further based on the physical item associated with the unique code of the identified user account and a physical item associated with a unique code associated with the at least one peer.

9. The method of claim 7, further comprising storing one or more rules specifying different progress levels required to earn one or more of the digital rewards, and updating the identified user account to include at least one of the digital rewards associated with the progress level corresponding to the real-world interaction.

10. The method of claim 9, further comprising identifying that another one of a plurality of other progress levels is associated with one or more requirements in accordance with the stored rules and that the requirements are achievable within a proximity of the user device, and generating a notification regarding the identified other progress level.

11. The method of claim 10, further comprising identifying another one of the peers associated with the achievable requirements, wherein the notification further specifies that the identified other progress level is achievable via a real-world interaction with the identified other peer.

12. The method of claim 9, wherein the at least one digital reward includes digital content configured to be presented within the digital environment in a next interactive session.

13. The method of claim 12, wherein the digital content is part of a collection of digital content.

14. The method of claim 13, wherein the stored information regarding the identified user account includes another part of the collection, and wherein the stored information regarding a user account of the at least one peer includes a different part of the collection.

15. The method of claim 14, further comprising updating the identified user account to include the different part of the collection associated with the at least one peer based on the real-world interaction, and updating the user account of the at least one peer to include the other part of the collection associated with the identified user account based on the real-world interaction.

16. The method of claim 13, wherein one or more other parts of the collection correspond to different digital rewards.

17. The method of claim 16, wherein the other parts of the collection are associated with different user accounts of other peers, and further comprising one or more of the other parts based on one or more real-world interactions with the other peers.

18. The method of claim 1, wherein the network device associated with the specified geographic location is one or more of a scanning device, a mobile device, the user device of the user of the identified user account, and a user device of the at least one peer.

19. A system for tracking multi-user engagement across real-world and digital environments, the system comprising:
a database in memory that stores information regarding a plurality of user accounts associated with different users, wherein the information regarding each of the user accounts includes data regarding interactions within a digital environment and a unique code that is also embedded in a physical item, and wherein the interactions are associated with one or more peers of a respective user;
a network device that reads the unique code embedded in the physical item and generates a check-in signal that includes the unique code, wherein the network device is associated with a specified geographic location at a current point in time; and
an engagement server that:
receives the check-in signal sent over a communication network from the network device;
identifies that the signal includes the unique code associated with an identified one of the user accounts;
determines that at least one of the peers of the user associated with the identified user account are also at the specified geographic location within an interval of the current point in time; and
generates a notification that identifies the at least one peer determined to be at the specified geographic location, the notification generated to be displayed on a user device associated with the identified user account.

20. A non-transitory computer-readable storage medium, having embodied thereon a program executable by a processor to perform a method for tracking multi-user engagement across real-world and digital environments, the method comprising:
storing information in memory regarding a plurality of user accounts associated with different users, wherein the information regarding each of the user accounts includes data regarding interactions within a digital environment and a unique code that is also embedded in a physical item, and wherein the interactions are associated with one or more peers of a respective user;
receiving a check-in signal over a communication network from a network device associated with a specified geographic location at a current point in time;
identifying that the signal includes the unique code associated with an identified one of the user accounts;
determining that at least one of the peers of the user associated with the identified user account are also at the specified geographic location within an interval of the current point in time; and
generating a notification that identifies the at least one peer determined to be at the specified geographic location, the notification generated to be displayed on a user device associated with the identified user account.
